(19) United States
(12) Patent Application Publication
(10) Pub. No.: US 2024/0222663 A1
(43) Pub. Date: Jul. 4, 2024

(54) FUEL CELL

(71) Applicant: TOYOTA JIDOSHA KABUSHIKI KAISHA, Toyota-shi (JP)

(72) Inventor: Takami HOSOI, Aichi-gun (JP)

(73) Assignee: TOYOTA JIDOSHA KABUSHIKI KAISHA, Toyota-shi (JP)

(21) Appl. No.: 18/545,226

(22) Filed: Dec. 19, 2023

(30) Foreign Application Priority Data
Dec. 28, 2022 (JP) 2022-211209

(51) Int. Cl. H01M 8/04082; H01M 8/04089; H01M 8/0438

(52) U.S. Cl. CPC H01M 8/04201; H01M 8/04089; H01M 8/04388

(57) ABSTRACT

A fuel cell disclosed in the present specification includes a fuel cell stack, a fuel pipe to supply fuel to the fuel cell stack, and a pressure sensor to measure pressure in the fuel pipe. The fuel pipe includes an outer pipe and an inner pipe inserted through the outer pipe. A gap between the outer pipe and the inner pipe is sealed at two locations in a longitudinal direction of the fuel pipe. A first through-hole is provided in an upper part of the outer pipe between the two locations, and a second through-hole is provided in a lower part of the inner pipe between the two locations. The pressure sensor is attached to the first through-hole.

### CROSS-REFERENCE TO RELATED APPLICATION

This application claims priority to Japanese Patent Application No. 2022-211209 filed on Dec. 28, 2022, incorporated herein by reference in its entirety.

### BACKGROUND

### 1. Technical Field

The technique disclosed in the present specification relates to a fuel cell.

### 2. Description of Related Art

Fuel cells are exemplified in Japanese Unexamined Patent Application Publication No. 2017-188254, Japanese Unexamined Patent Application Publication No. 2007-280696, and Japanese Unexamined Patent Application Publication No. 2006-244786. A fuel cell has a fuel cell stack and a fuel pipe that connects the fuel cell stack and a fuel tank. A pressure sensor is attached to the fuel pipe. Water can get into the fuel pipe. When water in the fuel pipe adheres to the pressure sensor, it may cause the pressure sensor to malfunction. In the fuel cell of JP 2017-188254 A, vibration of a hydrogen circulation pump connected to the fuel pipe prevents water from adhering to the pressure sensor.

### SUMMARY

The present specification provides a structure that makes it difficult for water to adhere to a pressure sensor attached to a fuel pipe.

An aspect of the disclosure relates to a fuel cell including a fuel cell stack, a fuel pipe, and a pressure sensor. The fuel pipe is configured to supply fuel to the fuel cell stack. The pressure sensor is configured to measure pressure in the fuel pipe. The fuel pipe includes an outer pipe and an inner pipe inserted through the outer pipe. A gap between the outer pipe and the inner pipe is sealed at two locations in a longitudinal direction of the fuel pipe. A first through-hole is provided in an upper part of the outer pipe between the two locations, and a second through-hole is provided in a lower part of the inner pipe between the two locations. The pressure sensor is attached to the first through-hole.

In the aspect, in a cross section transverse to the longitudinal direction and across the second through-hole, a first edge of the second through-hole may have a higher vertical height than a second edge of the second through-hole.

In the aspect, the outer pipe may be fixed to the fuel cell stack.

In the aspect, the inner pipe may be fixed to an injector configured to inject fuel.

In the aspect, the injector may be fixed to the fuel cell stack.

Fuel gas containing water flows through the inner pipe. Water may splash inside the inner pipe due to the momentum of the fuel gas, but it is difficult for the water to enter the gap between the inner pipe and the outer pipe. In particular, the second through-hole (hole of inner pipe) is located in the lower part of the inner pipe, and the first through-hole (hole of outer pipe) is located in the upper part of the outer pipe, so even water that enters the gap through the second through-hole would not reach the first through-hole. Thus, with the aspect of the present disclosure, water is prevented from adhering to the pressure sensor.

Details and further improvements in the aspect of the present disclosure are described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a fuel cell according to an example;

FIG. 2 is a perspective view of the periphery of a pressure sensor of the fuel cell;

FIG. 3 is a plan view of the periphery of the pressure sensor of the fuel cell;

FIG. 4 is a cross-sectional view of the fuel cell taken along the line IV-IV of FIG. 3; and

FIG. 5 is a cross-sectional view of the fuel cell taken along the line V-V of FIG. 3.

### DETAILED DESCRIPTION OF EMBODIMENTS

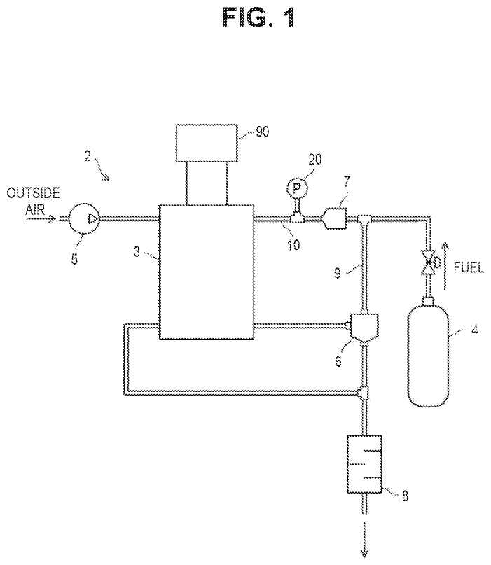

A fuel cell 2 of an example will be described with reference to the drawings. Hereinafter, for convenience of description, “fuel cell” may be abbreviated as “FC”, and “fuel cell stack” may be abbreviated as “FC stack”. FIG. 1 illustrates a block diagram of the fuel cell 2 (FC 2). The FC 2 includes an FC stack 3, a fuel tank 4, a compressor 5, and an injector 7. Fuel (hydrogen gas) in the fuel tank 4 is supplied to the FC stack 3 through a fuel pipe 10. The injector 7 and a pressure sensor 20 are attached to the middle of the fuel pipe 10. The injector 7 injects the fuel in the fuel tank 4 at an appropriate pressure. The pressure sensor 20 is provided between the FC stack 3 and the injector 7 and measures the pressure of fuel supplied to the FC stack 3.

Outside air (oxygen) is supplied to the FC stack 3 from the compressor 5. As is well known, in the FC stack 3, oxygen contained in the air reacts with fuel (hydrogen gas) supplied from the fuel tank 4 to obtain electricity. The power generated by the FC stack 3 is sent to an electrical device 90.

The fuel after the reaction is separated into reusable fuel gas and water by a gas-liquid separator 6. Recycled fuel gas is returned to the injector 7 by a return pipe 9. Water is discharged through a muffler 8 together with air. The structure of the FC 2 is greatly simplified in FIG. 1.

The fuel after the reaction is separated into reusable fuel gas and water in the gas-liquid separator 6, but some of the water turns into steam and mixes with the fuel gas. Therefore, between the injector 7 and the FC stack 3, a relatively large amount of water (steam) is in the fuel pipe 10. The pressure sensor 20 is attached to the fuel pipe 10 between the injector 7 and the FC stack 3. Water adhering to a sensor element of the pressure sensor 20 may affect the measurement accuracy. In the FC 2 of the example, the fuel pipe 10 is improved so that the sensor element of the pressure sensor 20 is less susceptible to adhesion of water. The structure of the fuel pipe 10 will be described hereinafter.

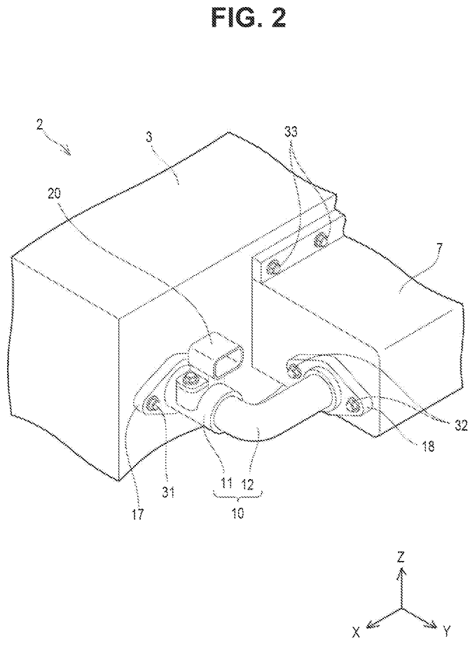

FIG. 2 illustrates a perspective view of the periphery of the pressure sensor 20. The fuel pipe 10 includes an outer pipe 11 connected to the FC stack 3 and an inner pipe 12 connected to the injector 7 and to the outer pipe 11. The inner diameter of the outer pipe 11 is larger than the outer diameter of the inner pipe 12. The inner pipe 12 is inserted inside the outer pipe 11. Although the details will be described below, the outer pipe 11 and the inner pipe 12 are sealed at two locations. In FIG. 2 (and subsequent figures), the FC stack 3 and the injector 7 are drawn in a simplified manner.

Both the outer pipe 11 and the inner pipe 12 are made of metal. A flange 17 is provided at one end of the outer pipe 11, and the flange 17 is fixed to an outer wall of the FC stack 3 with a bolt 31. A flange 18 is also provided at one end of the inner pipe 12, and the flange 18 is fixed to an outer wall of the injector 7 with a bolt 32. The injector 7 is fixed to the outer wall of the FC stack 3 with a bolt 33. These structures firmly fix the fuel pipe 10 made of metal to the FC stack 3. The pressure sensor 20 is attached to the outer pipe 11. Since the fuel pipe 10 is firmly supported by the FC stack 3, the pressure sensor 20 is indirectly also firmly supported by the FC stack 3.

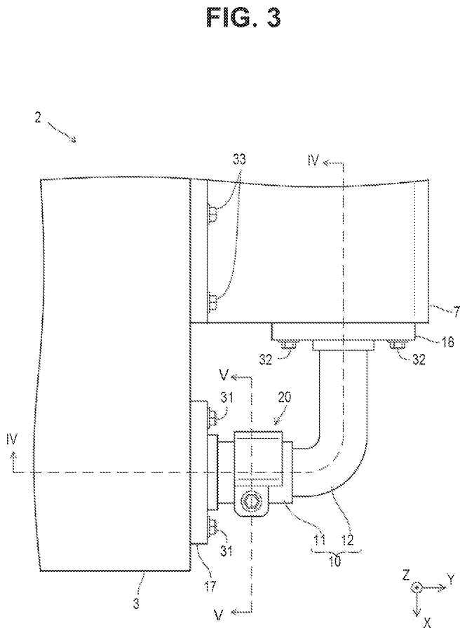

FIG. 3 illustrates a plan view of a vicinity of the pressure sensor 20. As illustrated in FIG. 3, the fuel pipe 10 is bent at a right angle between the FC stack 3 and the injector 7. Also, the pressure sensor 20 is adjacent to the FC stack 3.

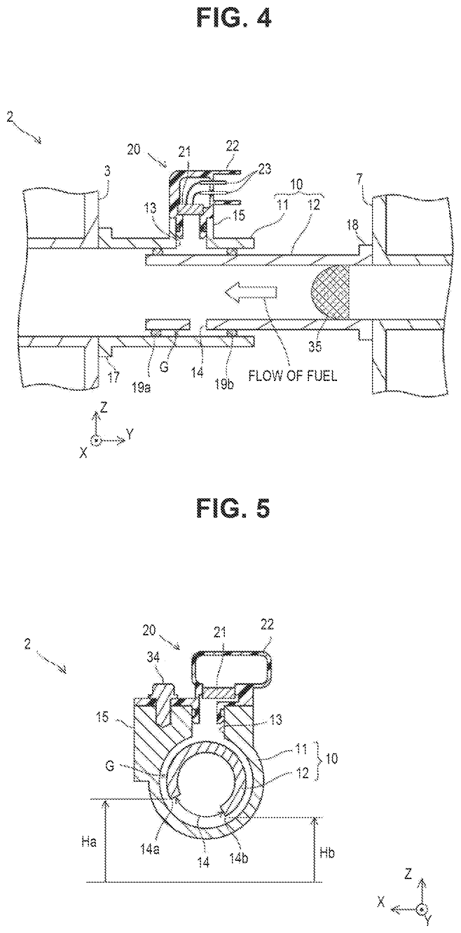

FIG. 4 illustrates a cross section along the IV-IV line of FIG. 3, and FIG. 5 illustrates a cross section along the V-V line of FIG. 3. FIG. 4 illustrates a longitudinal cross section along a longitudinal direction of the fuel pipe 10, and FIG. 5 illustrates a transverse cross section across the fuel pipe 10. A+Z direction of the coordinate system in the drawing corresponds to a vertically upward direction. The X-axis and Y-axis of the coordinate system in the drawing are parallel to the horizontal. The fuel pipe 10 is arranged so that its longitudinal direction is horizontal between the FC stack 3 and the injector 7.

As described above, the inner pipe 12 is inserted inside the outer pipe 11. A gap G is designed between an inner circumference of the outer pipe 11 and an outer circumference of the inner pipe 12. A space between the inner circumference of the outer pipe 11 and the outer circumference of the inner pipe 12 is sealed with two O-rings 19a, 19b. In other words, the space between the inner circumference of the outer pipe 11 and the outer circumference of the inner pipe 12 is sealed at two points in the longitudinal direction of the fuel pipe 10. A first through-hole 13 is provided in an upper portion of the outer pipe 11 between the two sealing locations, and a second through-hole 14 is provided in a lower portion of the inner pipe 12. That is, the gap G between the outer pipe 11 and the inner pipe 12 communicates with a space inside the inner pipe 12 and is isolated from a space outside the fuel pipe 10. The pressure in the gap G corresponds to the pressure inside the inner pipe 12, that is, the internal pressure of the fuel pipe 10.

A resin body 22 of the pressure sensor 20 is attached to the first through-hole 13 of the outer pipe 11. The resin body 22 is fixed to a block 15 provided outside the outer pipe 11 with a bolt 34. A pressure sensor element 21 is attached to the resin body 22 so as to be exposed to the first through-hole 13. The space to which the pressure sensor element 21 is exposed communicates with the space inside the fuel pipe 10 through the first through-hole 13 and the second through-hole 14. This structure allows the pressure sensor element 21 to measure the pressure inside the fuel pipe 10. A metal terminal 23 is provided on the resin body 22, and the metal terminal 23 is connected to the pressure sensor element 21. A part of the metal terminal 23 is exposed to the outside space so that it can be connected to an external connector.

A flow velocity of the fuel gas discharged from the injector 7 is high, so water (steam) may splash inside the fuel pipe 10. The fuel pipe 10 has a double pipe structure at the attaching location of the pressure sensor 20 (pressure sensor element 21). This structure makes it difficult for water contained in the fuel to adhere to the pressure sensor element 21. In particular, each of the structural features listed below makes it difficult for water to adhere to the pressure sensor element 21.

The second through-hole 14 is provided in a lower part of the inner pipe 12 in a vertical direction, and the first through-hole 13 is provided in an upper part of the outer pipe 11 in the vertical direction. The outer wall of the inner pipe 12 faces the first through-hole 13. The pressure sensor element 21 is arranged vertically above the outer pipe 11.

Also, the fuel gas flows from the inner pipe 12 toward the outer pipe 11. By arranging the outer pipe 11 downstream (downstream of the fuel gas flow) of the inner pipe 12, the water contained in the fuel gas does not come into significant contact with the O-ring 19a sealing between the outer pipe 11 and the inner pipe 12. By fixing the inner pipe 12 to the injector 7 and fixing the outer pipe 11 to the FC stack 3, the outer pipe 11 is arranged downstream of the inner pipe 12.

FIG. 5 illustrates a cross section transverse to the longitudinal direction of the fuel pipe 10 and across the first through-hole 13 and the second through-hole 14. In this cross section, a height Ha (position Ha in the vertical direction) in the vertical direction of a first edge 14a of the second through-hole 14 is higher than a height Hb (position Hb in the vertical direction) in the vertical direction of a second edge 14b of the second through-hole 14. The narrower the width of the second through-hole 14 in the cross section of FIG. 5, the more favorable it is. However, when the width of the second through-hole 14 is extremely narrow, the gap G may be isolated from the inner space of the inner pipe 12 when water freezes at the bottom of the outer pipe 11. By making the heights in the vertical direction of the edges 14a and 14b different, even when the second edge 14b is clogged with ice, the communication between the inner space of the inner pipe 12 and the gap G is maintained on the first edge 14a side.

Points to note regarding the technology described in the example will be described. The pressure sensor 20 is supported by the FC stack 3 via the outer pipe 11 made of metal. The pressure sensor 20 is prevented from shaking. The pressure sensor 20 is arranged next to the FC stack 3. The FC stack 3 generates heat due to the reaction between hydrogen and oxygen. The heat of the FC stack 3 is transmitted to the pressure sensor 20 through the outer pipe 11 made of metal. The heat of the FC stack 3 prevents water from freezing near the pressure sensor 20.

The inner pipe 12 is fixed to the injector 7 and the injector 7 is fixed to the FC stack 3. Both ends of the fuel pipe 10 are supported by the FC stack 3, so that the fuel pipe 10 (that is, the pressure sensor 20) is firmly supported.

A filter 35 is attached upstream of the pressure sensor 20 of the fuel pipe 10. The filter 35 removes dust contained in fuel discharged from the injector 7.

Although specific examples of the present disclosure are described in detail above, these are merely examples and do not limit the scope of the claims. The technique described in the claims includes various modifications and changes of the specific examples exemplified above. The technical elements described in the present specification or drawings exhibit technical usefulness alone or in various combinations, and are not limited to the combinations disclosed in the claims at the time of filing. In addition, the technique exemplified in the present specification or drawings can achieve a plurality of objectives at the same time, and achieving one of itself has technical usefulness.

What is claimed is:

1. A fuel cell comprising:
a fuel cell stack;
a fuel pipe configured to supply fuel to the fuel cell stack; and
a pressure sensor configured to measure pressure in the fuel pipe, wherein
the fuel pipe includes an outer pipe and an inner pipe inserted through the outer pipe, and a gap between the outer pipe and the inner pipe is sealed at two locations in a longitudinal direction of the fuel pipe,
a first through-hole is provided in an upper part of the outer pipe between the two locations, and a second through-hole is provided in a lower part of the inner pipe between the two locations, and
the pressure sensor is attached to the first through-hole.

2. The fuel cell according to claim 1, wherein in a cross section transverse to the longitudinal direction and across the second through-hole, a first edge of the second through-hole has a higher vertical height than a second edge of the second through-hole.

3. The fuel cell according to claim 1, wherein the outer pipe is fixed to the fuel cell stack.

4. The fuel cell according to claim 3, wherein the inner pipe is fixed to an injector configured to inject fuel.

5. The fuel cell according to claim 4, wherein the injector is fixed to the fuel cell stack.
